(19) United States
(12) Patent Application Publication
(10) Pub. No.: US 2019/0149183 A1
(43) Pub. Date: May 16, 2019

(54) APPARATUS AND METHOD FOR APPLYING A PROTECTIVE COVER ON AN ELECTRONIC DEVICE

(71) Applicant: R.R. Donnelley & Sons Company, Chicago, IL (US)

(72) Inventors: Brian R. Techter, Elburn, IL (US); Joseph K. Schewe, Glen Ellyn, IL (US); Laura Ruhaak, Brookfield, IL (US); Jinchun Zhang, Dongguan City (CN)

(21) Appl. No.: 16/184,320

(22) Filed: Nov. 8, 2018

Related U.S. Application Data
(60) Provisional application No. 62/585,355, filed on Nov. 13, 2017.
(60) Provisional application No. 62/584,522, filed on Nov. 10, 2017.

(51) Int. Cl. H04B 1/3888; H04M 1/02; B32B 37/00; B32B 17/06; B32B 7/12

(52) U.S. Cl. CPC H04B 1/3888; H04M 1/0202; B32B 37/0046; B32B 2457/20; B32B 7/12; B32B 2307/584; B32B 17/06

(57) ABSTRACT

According to one aspect, an application apparatus comprises a first portion having a recessed portion, a displaceable ejection element movable with respect to the recessed portion, and a first positioning surface. A second portion includes a holder and a second positioning surface. The first portion is mateable with the second portion when the first positioning surface is brought into abutment with the second positioning surface such that the recessed portion is disposed adjacent the holder. The ejection element is manually displaceable after mating of the first portion with the second portion to deposit a protective element adapted to be disposed in the recessed portion on a device adapted to be disposed in the holder. A method of applying a protective cover to an electronic device is also disclosed.

### CROSS REFERENCE TO RELATED APPLICATIONS

The present application claims the benefit of Techter et al., U.S Provisional Patent Application No. 62/585,355, filed Nov. 13, 2017; and Techter et al., U.S. Provisional Patent Application No. 62/584,522, filed Nov. 10, 2017. Both these applications are entitled “Apparatus and Method for Applying a Protective Cover on an Electronic Device.” The entire contents of these applications are incorporated herein by reference.

### FIELD OF DISCLOSURE

The present subject matter relates to apparatuses and methods for applying a protective cover on an electronic device, and more particularly, to an apparatus and method for aligning the protective cover with the electronic device before adhering the protective cover thereto.

### BACKGROUND

Electronic devices, such as smartphones, electronic tablets, and the like have screens that may crack, break, or otherwise become damaged if such devices are dropped or otherwise mishandled. A transparent protective cover may be secured to the screen of an electronic device that prevents such damage to the screen. The cover must be properly aligned with the screen as the cover is being adhered thereto, which can be problematic inasmuch as the adhesive may grip the screen before the cover has been properly positioned, leading to misalignment.

### BRIEF DESCRIPTION OF THE DRAWINGS

FIG. 1 is an isometric view of a package including an apparatus for securing a protective cover to an electronic device;

FIGS. 2 and 3 are isometric views of an interior of the package of FIG. 1;

FIG. 4 is an isometric view of a cover tray and electronic device holder disposed inside the package of FIG. 1 and an envelope removed from such package;

FIG. 5 is an isometric view of an electronic device holder disposed in the package of FIG. 1, and the envelope and cover tray removed from such package;

FIG. 6 is an isometric view of an electronic device disposed in the device holder of FIG. 5;

FIG. 7 is an isometric view of the cover tray disposed over the electronic device of FIG. 6;

FIG. 7A is a cross-sectional view taken along the lines 7A-7A of FIG. 7 with some elements omitted for clarity;

FIG. 8 is another isometric view of the cover tray disposed over the electronic device of FIG. 6;

FIG. 9 is an isometric exploded view of the cover tray and the electronic device holder of the package of FIG. 1;

FIG. 10 is an isometric exploded view of package of FIG. 1 and the contents thereof;

FIG. 11 is an isometric view of another embodiment of a cover tray and device holder of the package of FIG. 1;

FIG. 12 is an isometric cross-sectional view taken generally along the lines 12-12 of FIG. 11;

FIG. 13 is a plan view of the cover tray and device holder of FIG. 11;

FIG. 14 is an isometric cross-sectional view taken generally along the lines 14-14 of FIG. 11;

FIG. 15 is another isometric view of the cover tray and device holder of the package of FIG. 1;

FIG. 16A is a perspective view of an envelope that may be disposed in the package of FIG. 1;

FIG. 16B is a perspective view of the envelop of FIG. 16A and an insert that may be disposed in such envelope;

FIG. 16C is a perspective view of the envelope of FIG. 16A disposed in the package of FIG. 1;

FIGS. 17A and 17B are perspective view of the package of FIG. 1;

FIGS. 18A and 18B are perspective views of the package of FIG. 1 with the lids of such package in open and closed positions;

FIG. 19 is an isometric view of the package of FIG. 1 with the lids of such package in an open position;

FIG. 20 is a plan view of another embodiment of a cover tray of the package of FIG. 1;

FIG. 20A is an isometric view of a portion of the cover tray of FIG. 20;

FIG. 21 is an isometric view of the cover tray of FIG. 20 with a protective cover disposed therein;

FIG. 22 is a cross-sectional view generally taken along lines 22-22 of FIG. 21;

FIG. 23 is an enlarged sectional view of a portion of the cover tray defined by lines 23-23 of FIG. 22;

FIG. 24 is a plan view of still another embodiment of the cover tray of the package of FIG. 1; and

FIG. 25 is a plan cross-sectional view taken along lines 25-25 of FIG. 24.

### SUMMARY

According to one aspect, an application apparatus comprises a first portion having a recessed portion, a displaceable ejection element movable with respect to the recessed portion, and a first positioning surface. A second portion includes a holder and a second positioning surface. The first portion is mateable with the second portion when the first positioning surface is brought into abutment with the second positioning surface such that the recessed portion is disposed adjacent the holder. The ejection element is manually displaceable after mating of the first portion with the second portion to deposit a protective element adapted to be disposed in the recessed portion on a device adapted to be disposed in the holder.

According to a further aspect, an application apparatus includes a package including a cover tray, an ejection element movable with respect to the cover tray, and an electronic device holder wherein the cover tray includes at least one protrusion and the electronic device holder includes at least one recess. A protective element is disposed in the package and the cover tray is mateable with the electronic device holder wherein the at least one protrusion is adapted to extend into the at least one recess such that the cover tray is disposed adjacent to and aligned with the electronic device holder. The ejection element is manually displaceable after mating of the cover tray with the electronic device holder to release the protective element from the cover tray.

According to yet another aspect, a method of applying a protective cover to an electronic device includes the step of providing a kit comprising a package having a cover tray, an electronic device holder, and a protective cover wherein the cover tray includes a movable ejection element. The method further includes the steps of placing the protective cover in the cover tray, removing the cover tray and the protective cover from the kit, and placing an electronic device in the electronic device holder. Still further, the method includes the steps of registering the cover tray with respect to the electronic device holder and flexing the movable ejection element to eject the protective element from the cover tray and deposit the protective cover on a desired location of the electronic device.

### DETAILED DESCRIPTION

Aspects and advantages of the apparatus and method of the embodiments described herein will become apparent upon consideration of the following detailed description and the attached drawings wherein like numerals designate like structures throughout the specification.

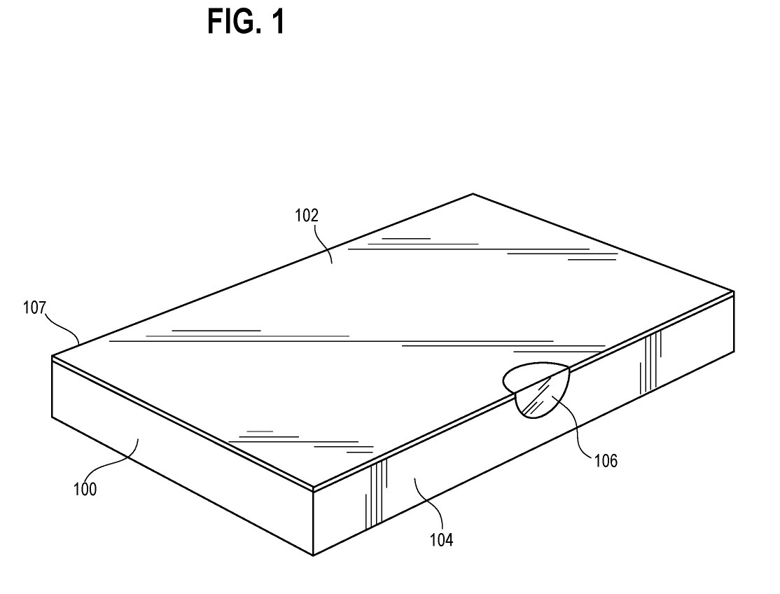

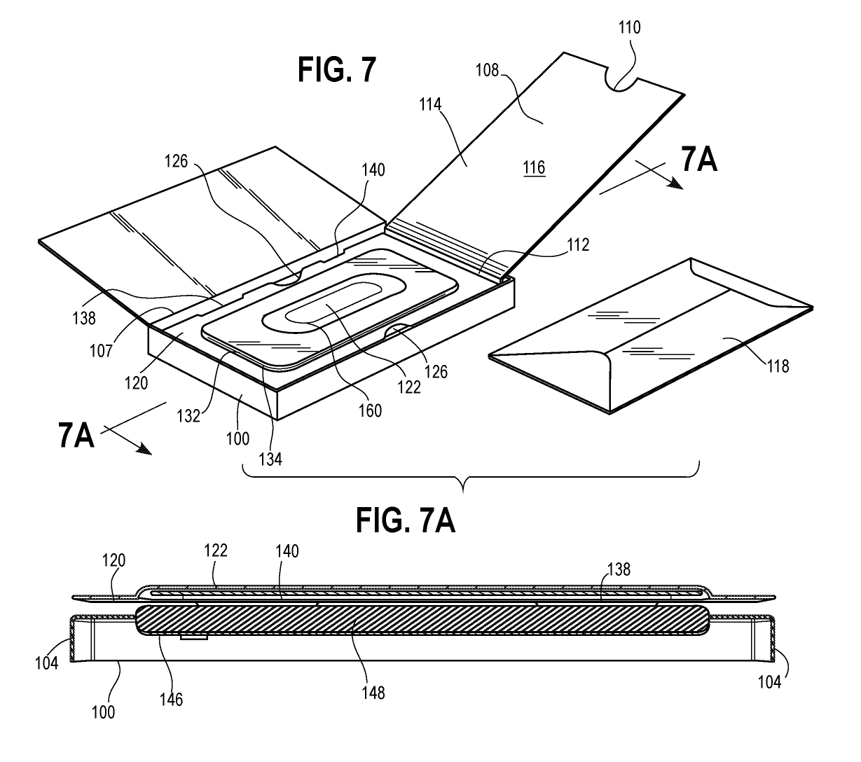

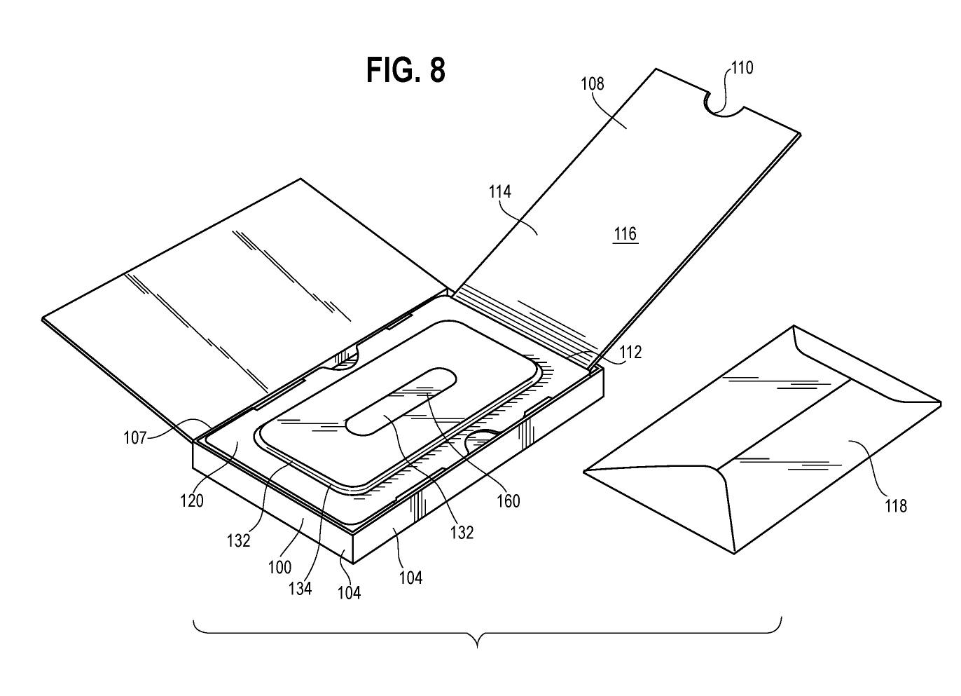

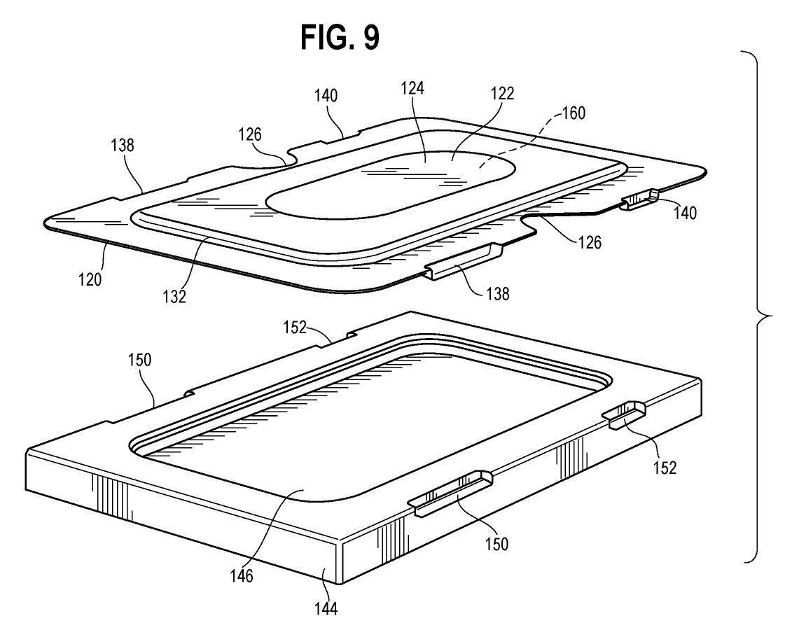

Referring to FIG. 1-11, a box-shaped package 100 includes a first lid or flap 102 secured to a side 104 thereof by, for example, a wafer seal 106. As described below, the package 100 houses components that facilitate registering (aligning) a protective cover with a screen of an electronic device, and thereafter securing the protective cover to the screen.

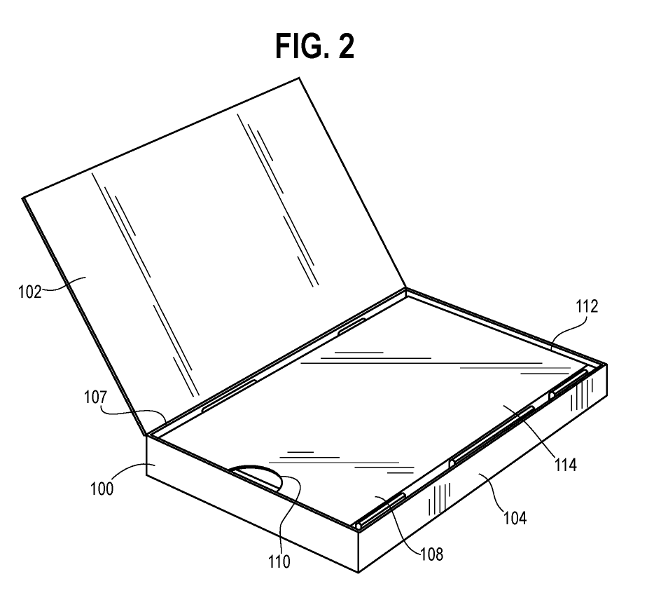

Referring to FIG. 2, after the wafer seal 106 is broken or removed, the first lid 102 may be opened about a hinged portion 107 to reveal a second lid 108. The second lid 108 includes a cutout 110 that facilitates lifting the second lid 108, and a hinged portion 112 about which a top portion 114 of the second lid 108 may be lifted.

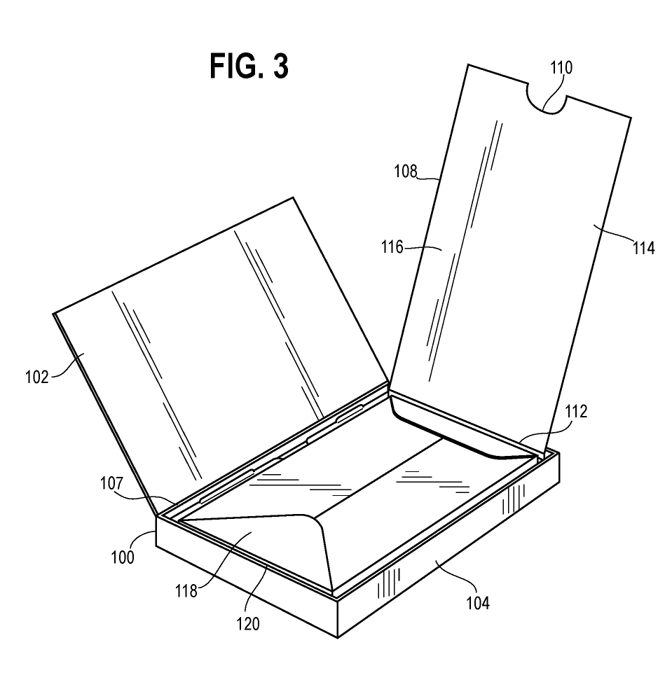

Referring to FIG. 3, once the top portion 114 of the second lid 108 is lifted about the hinge portion 112, an inner surface 116 of the top portion 114 may be exposed. In some embodiments, such inner surface 116 is imprinted with instructions for how to use the components enclosed in the package 100 to apply a protective cover to an electronic device.

Lifting the top portion 114 also exposes an optional envelope 118 disposed between a cover tray 120 and the second lid 108. Accessories (not shown) and additional instructional or informational materials may be disposed in the envelope 118.

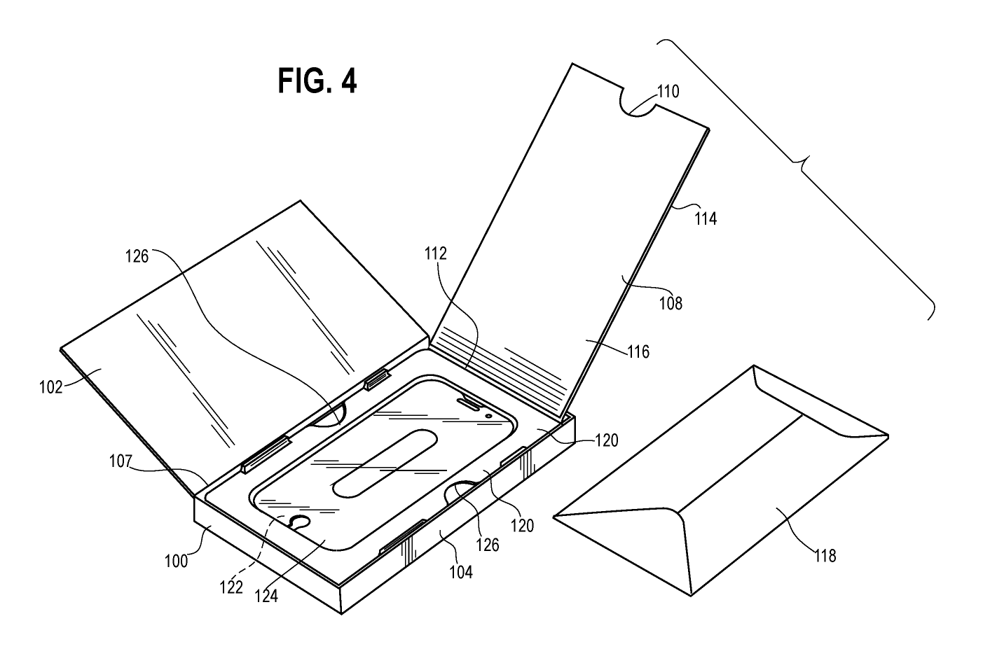

Referring to FIG. 4, removing the envelope 118 further exposes a cover tray 120 and a protective cover 122 disposed on the cover tray 120. A removable protective film or liner 124 is adhesively secured to the protective cover 122. The cover tray 120 includes a plurality of cutouts 126 that may be grasped to remove the cover tray 120 from the package 100.

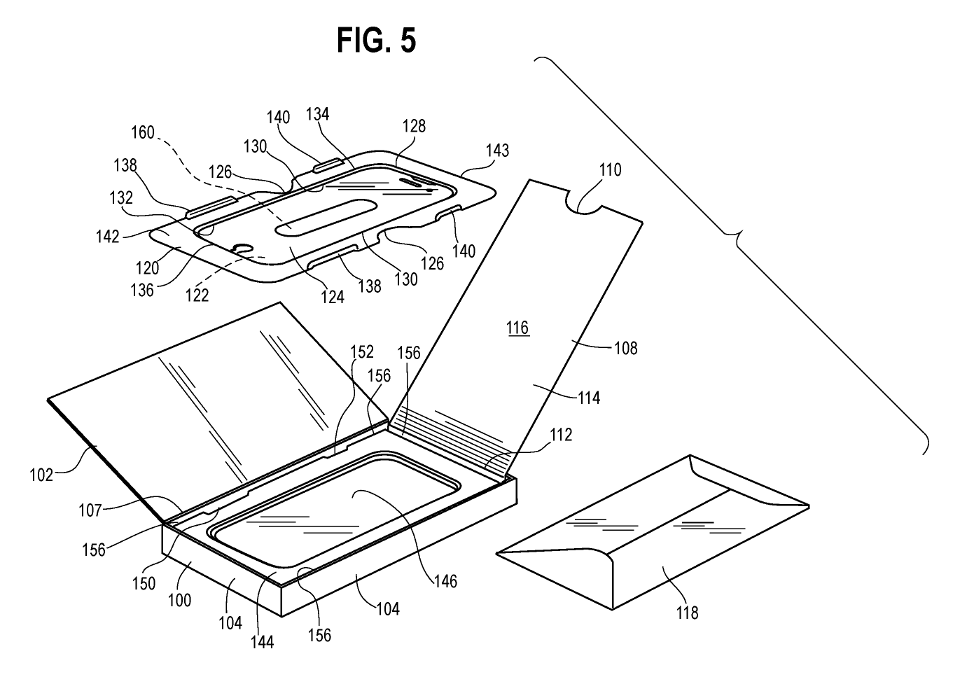

Referring also to FIG. 5, in addition, the cover tray 120 includes a recessed portion 128 into which the protective cover 122 may be disposed. Further, the dimensions of an interior perimeter 130 of the recessed portion 128 are substantially identical to the dimensions of an outer perimeter 132 of the protective cover 122. Thus, when the protective cover 122 is inserted into the recessed portion 128, friction between walls 134 defining the recessed portion 128 and outer walls 136 of the protective cover 122 retains the protective cover 122 in the recessed portion 128.

The cover tray 120 also includes one or more first protrusions 138 and one or more second protrusions 140 extending outwardly from an outer surface 142 of the cover tray 120. In an exemplary embodiment, the dimensions (for example, the length, width, and/or depth) of the first protrusions 138 and the dimensions of the second protrusions 140 are substantially different. In some embodiments, the shapes of the first and second protrusions 138,140 are identical, and in other embodiments such shapes are different. Further, in some embodiments, the first protrusions 138 and the second protrusions 140 are disposed along a perimeter 143 of the cover tray 120. In other embodiments, one or more of the first and second protrusions 138,140 are disposed spaced apart from the perimeter 143.

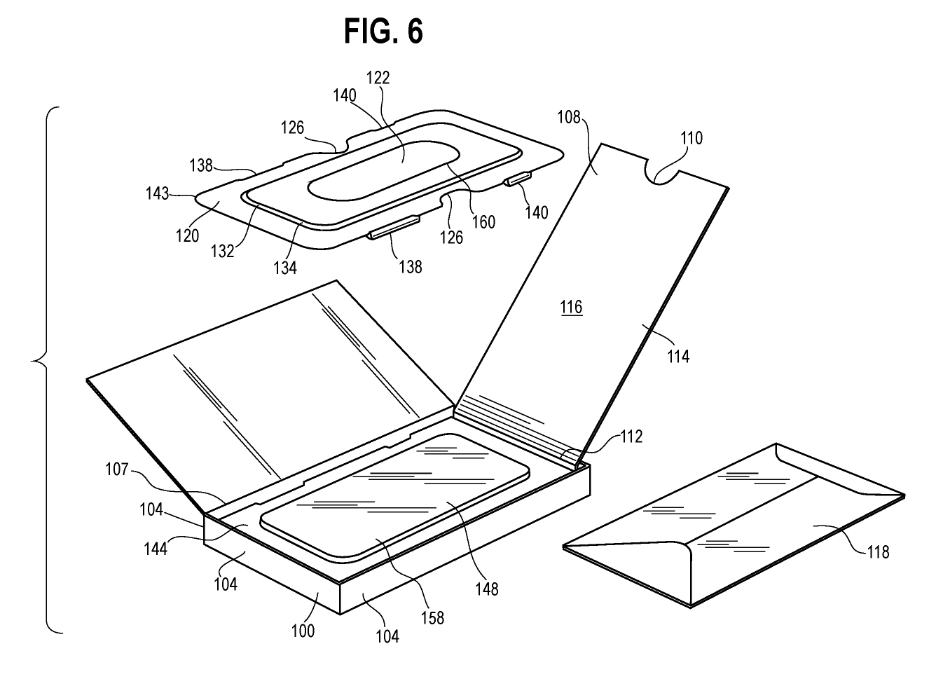

Referring to FIGS. 5 and 6, the cover tray 120 may be lifted away from the package 100 by grasping the cutouts 126. Doing so exposes a recessed portion 146 of an electronic device holder 144 into which an electronic device 148 (FIG. 6) may be inserted.

The electronic device holder 144 also includes one or more first orifices or recesses 150 and one or more second orifices or recesses 152. In some embodiments, the first orifices or recesses 150 and the second orifices or recesses 152 are positioned along a perimeter 154 of the device holder 144. Further, when the device holder 144 is positioned in the package 100 the first orifices or recesses 150 and the second orifices or recesses 152 are disposed adjacent the interior surfaces 156 of the walls 104 of the package 100. In other embodiments, the first orifices or recesses 150 and the second orifices or recesses 152 are disposed in a spaced relationship away from the perimeter 154.

There is a one-to-one correspondence between the first orifices or recesses 150 and the first protrusions 138, and the second orifices or recesses 152 and the second protrusions 140. Further, the protrusions 138,140 and the orifices or recesses 150,152 are disposed on the cover tray 120 and the electronic device holder 144, respectively, such that when the first and second protrusions 138, 140 are brought into alignment with corresponding first and second orifices or recesses 150,152, the recessed portion 128 of the cover tray 120 (and the protective cover 122 retained therein) is aligned with the recessed portion 146 in the electronic device holder 144 (and the electronic device 148 disposed therein). The protrusions 138,140 may be disposed on the cover tray 120 such that each protrusion 138,140 aligns with a recess 150,152 of the electronic device holder 144 only when the cover tray 120 and the electronic device holder 144 are in alignment and in a correct orientation with one another.

Referring to FIGS. 6-9, to apply the protective cover 122 to the screen 158 of the electronic device 148, the electronic device 148 is inserted into the recess 146 in the device holder 144. If necessary, the protective cover 122 is inserted into the recessed portion 128 of the cover tray 120. The protective film 124 adhered to the protective cover 122 is removed to expose an adhesive disposed on the protective cover 122. Thereafter, the protective cover 122 is turned over so that the exposed adhesive faces the screen 158 of the electronic device 148. The perimeter 143 of the cover tray 120 is then aligned with the interior surfaces 156 of the walls 104 of the package 100 such that the first protrusions 138 and the second protrusions 140 are aligned with the first orifices or recesses 150 and the second orifices or recesses 152, respectively. The cover tray 120 is then disposed on the device holder 144 such that the first protrusions 138 are received in the first orifices or recesses 150, the second protrusions 140 are received in the second orifices or recesses 152. In some embodiments, the shape and/or dimensions of the first orifice 150 are such that the first protrusion 138 fits therein and the shape and/or dimensions of the second orifice 150 are such that the second protrusion 140 fits therein. In some embodiments, the shape and/or dimensions of the second orifice 150 are such that the first protrusion 138 does not fit therein. Selecting the shapes and/or dimensions of the orifices 150,152 and the protrusions 138,142 in this manner prevents misalignment of the protective cover relative to the screen of the electronic device.

In some embodiments, the cover tray 120 includes a central cutout 160 that exposes the protective cover 122 therethrough. In such embodiments, after the adhesive is in contact with screen 158, pressure may be applied for example, by one or more fingers of a user, to the protective cover 122 through the central cutout 160 to urge the protective cover 122 toward the screen 158. Applying sufficient pressure overcomes the friction between the walls 134 of the recessed portion 128 of the cover tray 120 and the walls 136 of the protective cover 122, and releases the protective cover 122 from the cover tray 120. Thereafter, if necessary or desirable, the cover tray 120 may be removed and additional pressure may be applied to the protective cover 122 to complete the method of securing the protective cover 122 to the screen 158.

In an exemplary embodiment, the adhesive is one that adheres relatively strongly to the material that comprises the screen 158 of the electronic device 148 and relatively weakly to the material that comprises the protective film 124. In such embodiment, the protective film 124 may be released from the adhesive, yet the adhesive secures the protective cover 122 to the electronic device 148.

In some embodiments, when the protective cover 122 is disposed in the cover tray 120, a low tack adhesive film (not shown) may be disposed on the cutout 160 to protect the protective cover 122 until use. In such embodiments, the protective cover 122 and the low tack adhesive film are disposed on opposite sides of the cover tray 120. Such low tack adhesive film may also facilitate holding the protective cover 122 in the recess 146. Such low tack adhesive film may be removed before or after pressure is applied through the cutout to secure the protective cover 122 to the screen.

In some embodiments, the cover tray 120 may be sufficiently flexible such that flexing the cover tray 120 after the protective cover 122 is disposed atop the electronic device 148 releases the protective cover 122 from the walls 132. In such embodiments, the cutout 160 and/or the low tack adhesive film may not be necessary.

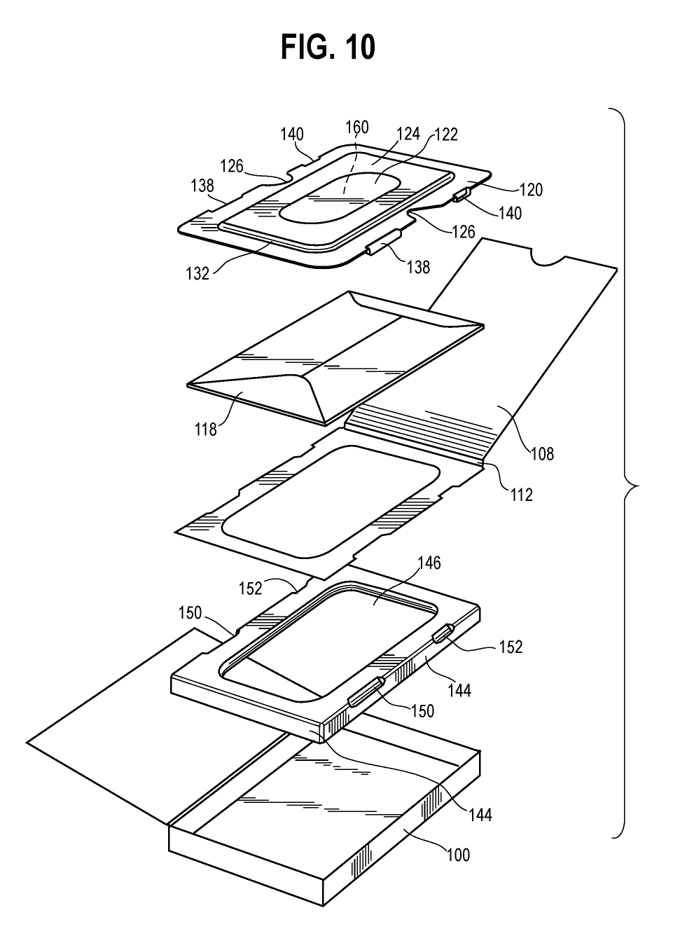

Referring to FIG. 10, the package 100, the cover tray 120, and the device tray 144 form a kit to facilitate alignment and securement of the protective cover 120 and the electronic device 148. The kit may further include the envelope 118 with additional materials (for example, a cleaning cloth, informational material, and/or the like) and/or the lid 108 to conceal and protect components disposed in the package 100. In some embodiments, the kit may include the protective cover 122. In such embodiments, the protective cover 122 may be provided already inserted in the recessed portion 128 of the cover tray 120. Alternatively, the protective cover 122 may be supplied in the envelope 118. In other embodiments, the kit may not include the protective cover 122 and the protective cover 122 may be acquired separately from the kit.

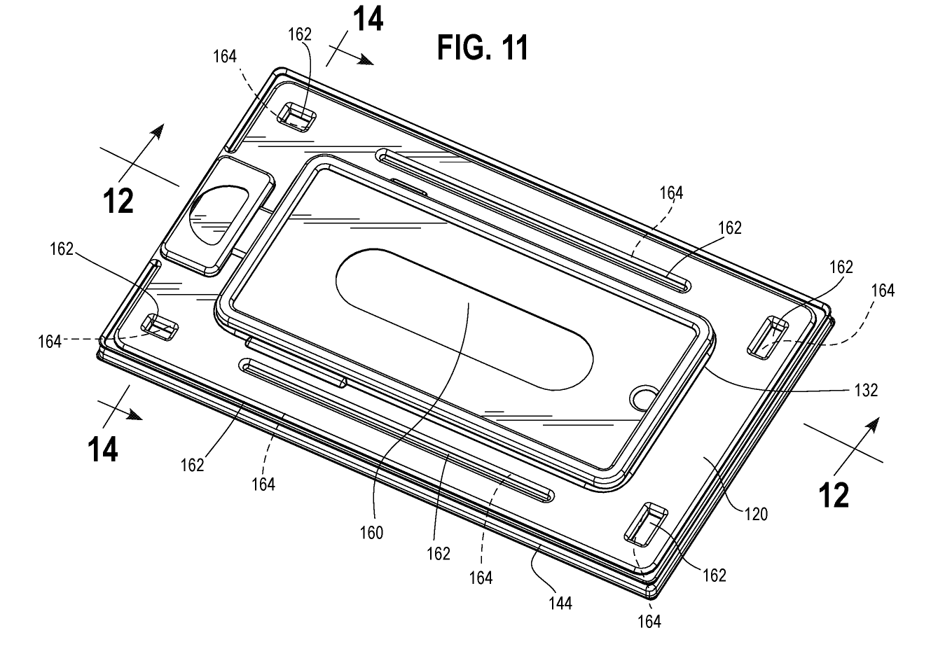

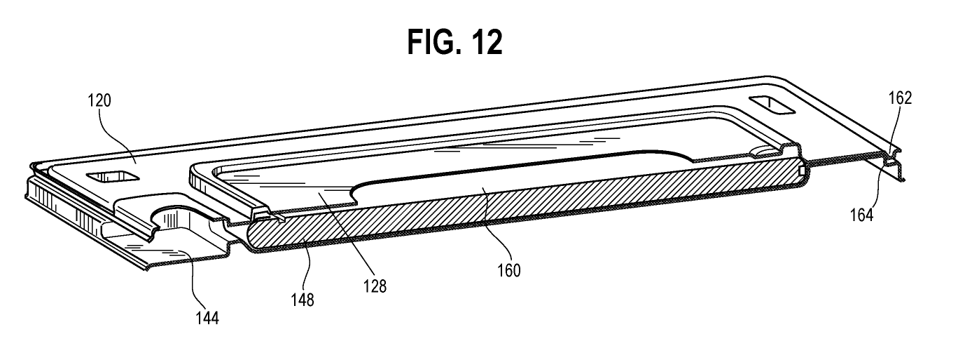

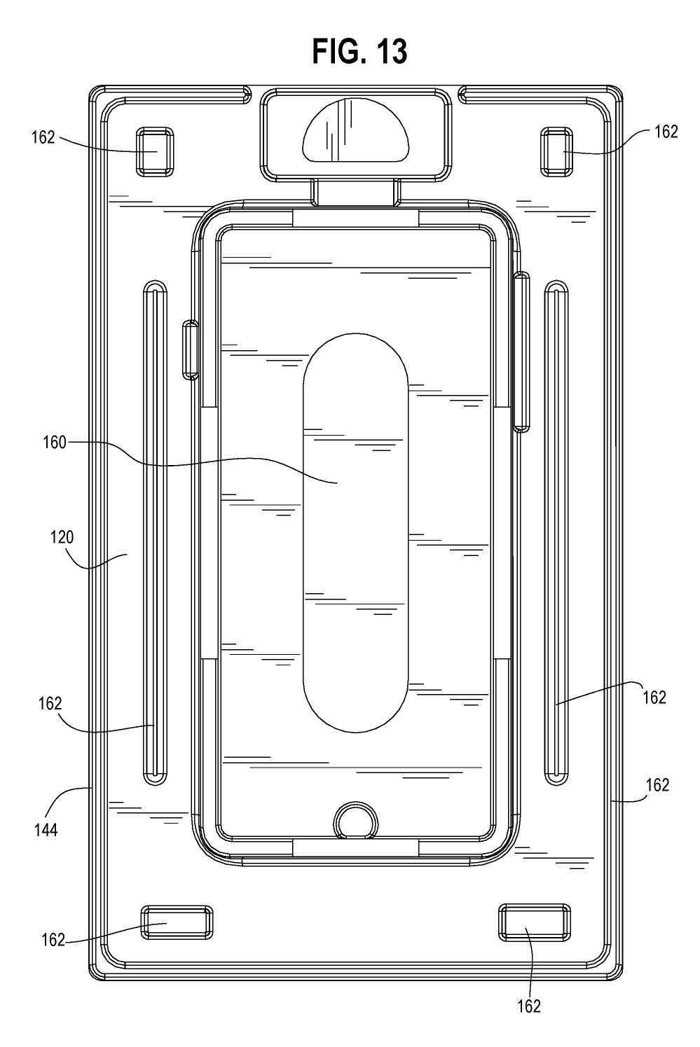

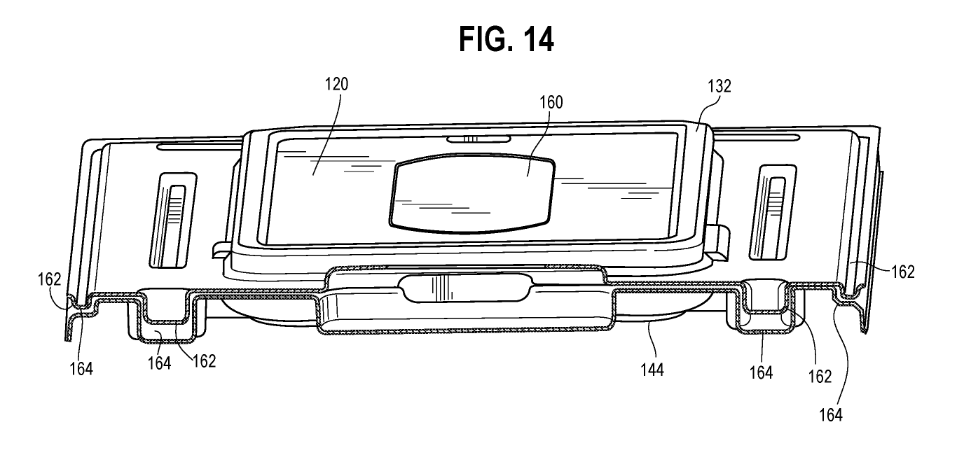

Referring to FIGS. 11-14, in some embodiments, the cover tray 120 may have protrusions 162 that are inserted into orifices or recesses 164 in the device holder for alignment. Further such protrusions 162 and orifices or recesses 164 may be spaced away from the perimeters of the cover tray and the device holder, respectively. However, the spacing between protrusions 162 is identical to the spacing between the orifices or recesses 164 such when the cover tray 120 (and thus the cover 122) is aligned with the device holder 144 (and thus the electronic device 148 disposed in the device holder 144), each orifice or recess 164 receives a corresponding protrusion 162.

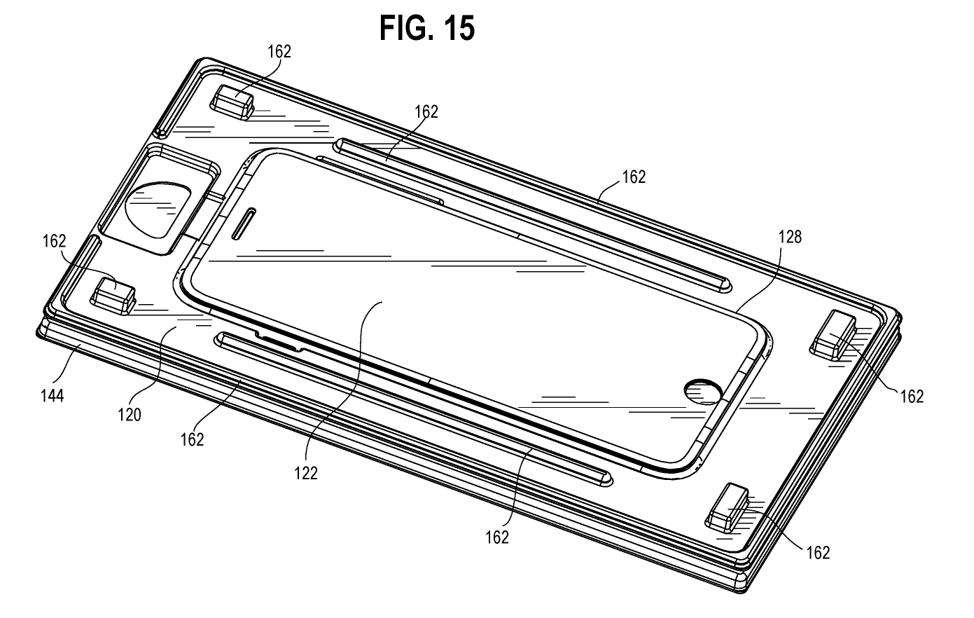

Referring to FIG. 15, in some embodiments, before the cover tray 120 is used to position the protective cover 122 on a device (not shown) disposed in the device holder 144 (for example, when the cover tray 120, protective cover 122, and device holder 144 are stored), the cover tray 120 may be disposed on top of the device holder 144 such that the cover tray 120 is between the device holder and the protective cover 122. Disposing the cover tray 120 in this manner may prevent the protective cover 122 disposed therein from becoming accidentally dislodged.

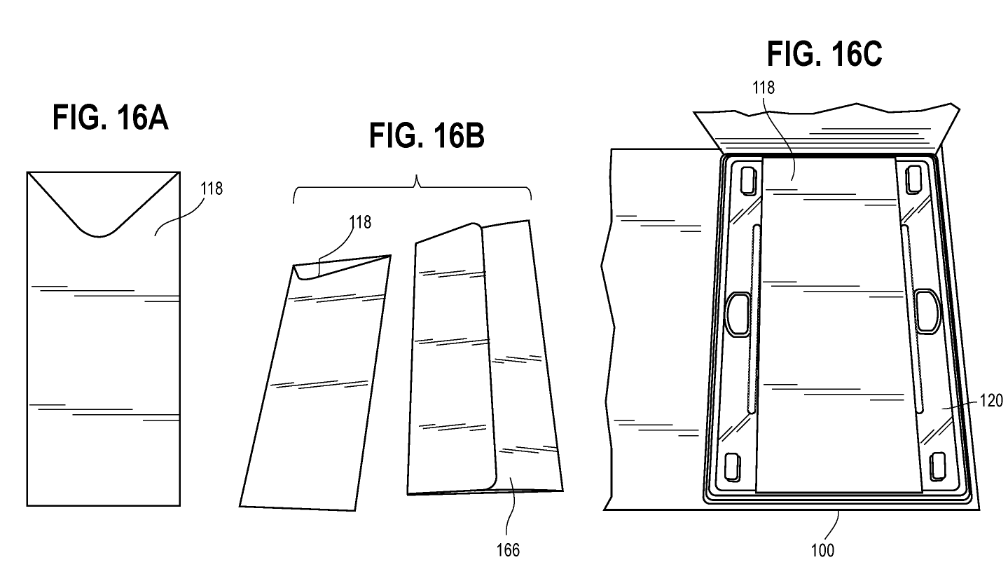

Referring to FIGS. 16A-16C, the envelope 118 may include one or more inserts 166 including, for example, a wipe cloth and/or page(s) of instructions and/or warranty information. The envelope 118 with such inserts may be disposed on top of the cover tray 120, and the cover tray 120 and envelope 118 may be disposed in the package 100.

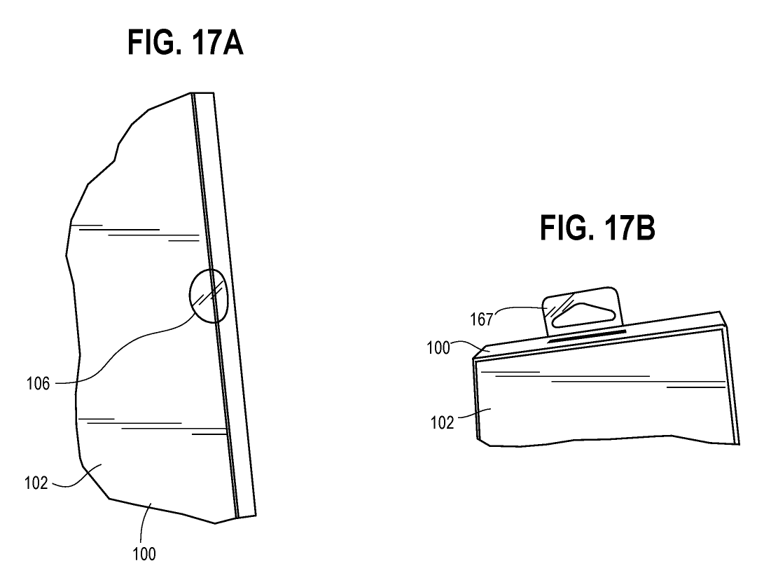

Referring to FIGS. 17A and 17B, as described above, the package 100 may include a wafer seal 106 that keeps the first lid 102 (FIG. 2) in a closed position. In some embodiments the package 100 includes a hangtag 167 that may be used to hang the package 100, for example, in a retail display.

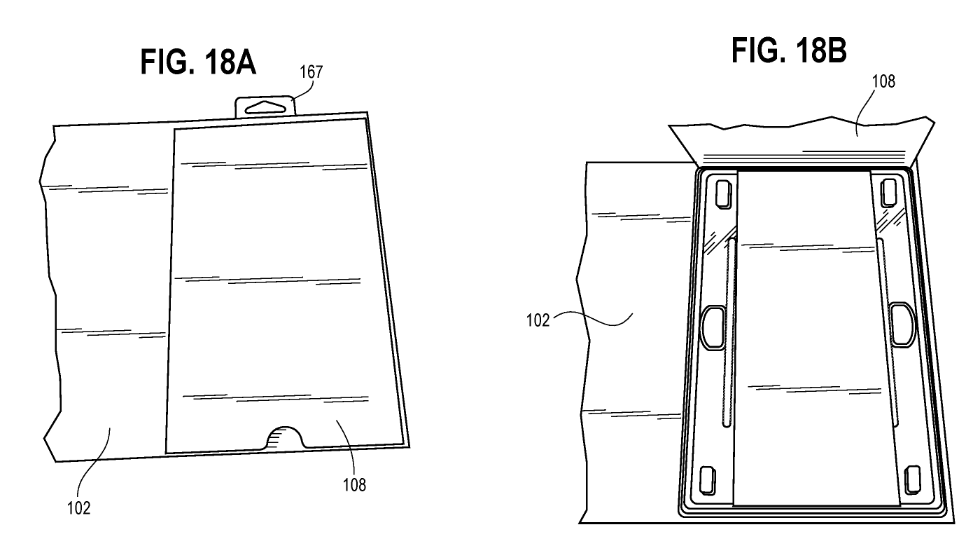

Referring to FIGS. 2, 18A, and 18B, FIG. 18A shows the package 100 with the first lid 102 in an open position and the second lid 108 in a closed position. FIG. 18B shows the package 100 with both first lid 102 and the second lid 108 in an open position.

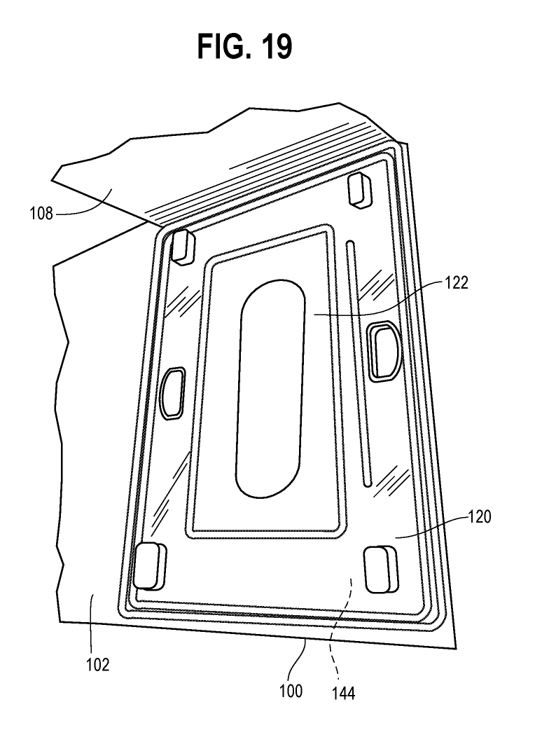

Referring to FIGS. 2, 15, and 19, FIG. 19 show the cover tray 120, the protective cover 122, and the device holder 144 disposed in the package 100.

The package 100, the cover tray 120, and/or the device holder 144 may be manufactured from any suitable material apparent to one of ordinary skill in the art including cardboard, metal, wood, glass, polystyrene, polypropylene, polyethylene terephthalate (PET), polyactide, polyvinyl chloride (PVC), nylon, other rigid polymers or resilient thermoplastic materials, oriented polystyrene (OPS), and/or combinations thereof

The protective cover 122 may be manufactured from a durable material, for example, Gorilla® Glass manufactured by the Corning Corporation of Corning, N.Y., Dragontrail™ Glass manufactured by Asahi Glass Co. of Tokyo, Japan, a highly durable plastic, and the like. As described above, the components of the apparatus described herein may be used to register (align) the protective cover 122 with and adhesively secure the protective cover 122 to the electronic device 148.

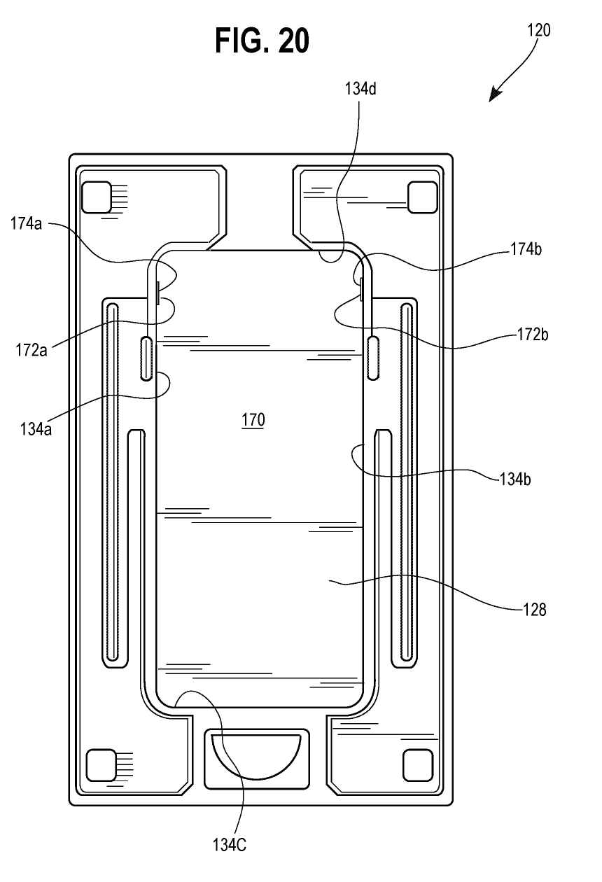

Referring to FIGS. 20 and 20A, in some embodiments, the cover tray 120 does not include a central cutout 160 as described above. To use such a cover tray 120, a protective cover 122 is inserted into the recessed portion 128 of the cover 120, if necessary. Then the cover tray 120 is positioned relative to and aligned with the device tray 144 as described above, so that the protective cover 122 faces and is adjacent the screen of the electronic device 148 disposed in the device tray 144, as described above. Thereafter, pressure is applied to a central portion 170 of the recessed portion 128, on the side of the cover tray 120 opposite the side in which the protective cover 122 is disposed, and such pressure urges the protective cover 122 to release from the recessed portion 128 and onto the electronic device 148.

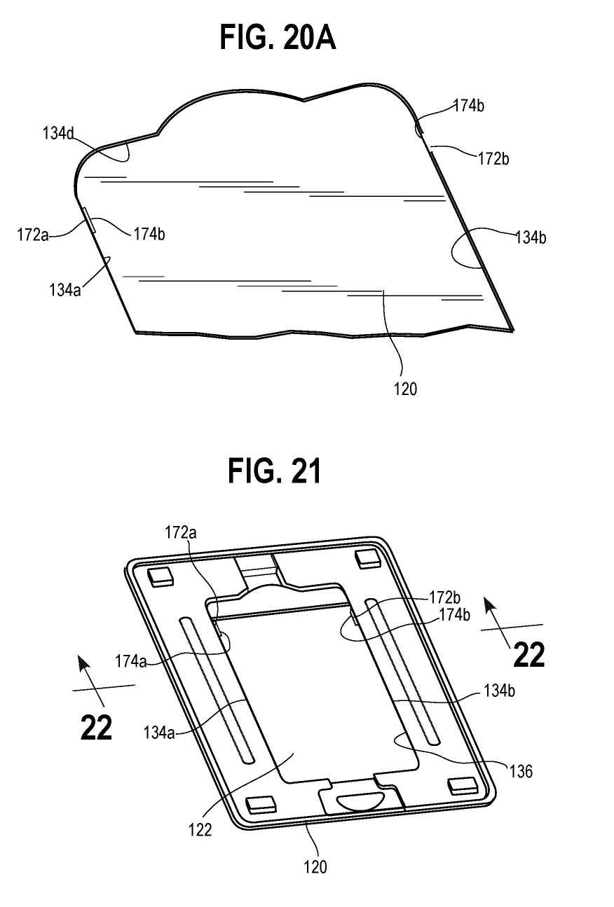

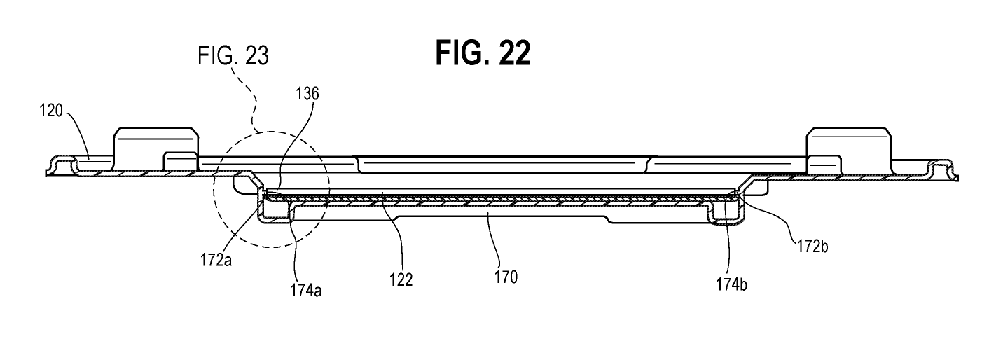

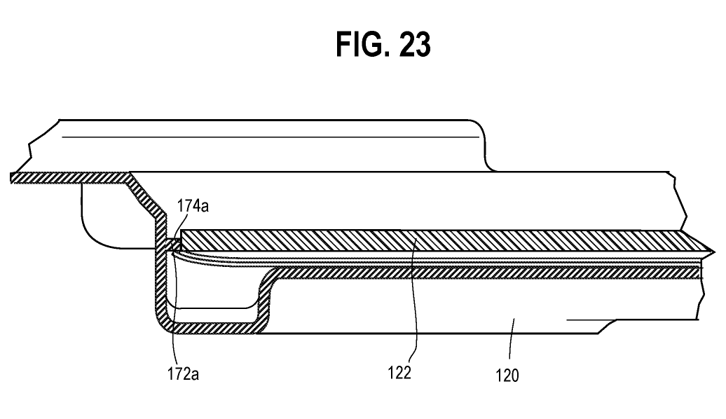

As described above, in some embodiments the protective cover 122 is retained in the recessed portion 128 by the walls 134 thereof. Referring to FIGS. 20-23, In other embodiments, the distance between opposite walls 134a and 134b of the recessed portion 128 may be larger than the width of the protective cover 122 that is disposed in the recessed portion 128. These walls 134a and 134b may include inset portions 172a and 172b, respectively, that extend inwardly into the recessed portion. In one embodiment, the inset portions 172a, 172b extend approximately 0.2 mm inwardly from the walls 134, 134b toward the central portion 170. Further, these inset portions 172a, 172b extend between approximately 5 mm and 7 mm along walls 134a, 134b, respectively. The distance between faces 174a and 174b of the inset portions 172a, 172b may be substantially identical to or slightly less than the width of the protective cover 122 so that friction and/or interference between the faces 174 and the outer walls of the protective cover 122 disposed in the recessed portion 128 help retain and position the protective cover 122 therein. Friction and/or interference between the opposite walls 134c and 134d and the outer walls 136 of the protective cover 122 may also assist in retaining the protective cover 122 in the recessed portion 128.

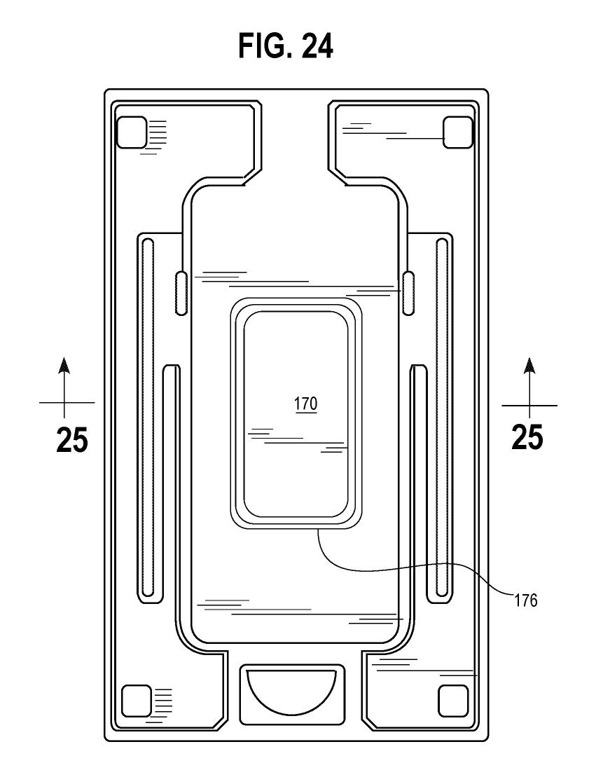

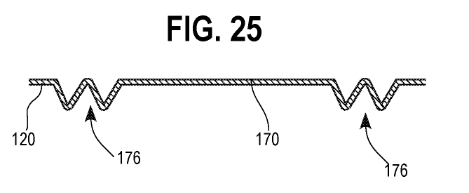

Referring to FIGS. 24 and 25, in some embodiments, the central portion 170 of the recessed portion 128 may be defined by folding or pleating a portion 176 of the cover tray 120, for example, to obtain an accordion fold. When a protective cover 122 is disposed in the recessed portion 128 and when pressure is applied to the portion 170, such folded portion 176 unfolds and facilitates flexing of the portion 170, and thereby facilitates release of the protective cover 122 from the recessed portion 128.

### INDUSTRIAL APPLICABILITY

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. An application apparatus, comprising:
a first portion having a recessed portion, a displaceable ejection element movable with respect to the recessed portion, and a first positioning surface; and
a second portion having a holder and a second positioning surface;
wherein the first portion is mateable with the second portion when the first positioning surface is brought into abutment with the second positioning surface such that the recessed portion is disposed adjacent the holder; and
wherein the ejection element is manually displaceable after mating of the first portion with the second portion to deposit a protective element adapted to be disposed in the recessed portion on a device adapted to be disposed in the holder.

2. The application apparatus of claim 1, in combination with a protective element disposed in the recessed portion and a device disposed in the holder.

3. The application apparatus of claim 2, wherein the protective element comprises a cover and the device comprises an electronic device.

4. The application apparatus of claim 2, wherein the device comprises a mobile phone having a screen and the protective element comprises a transparent cover deposited on the screen.

5. The application apparatus of claim 1, wherein the first portion and second portion comprise parts of a package.

6. The application apparatus of claim 5, further including a protective element disposed in the package.

7. The application apparatus of claim 1, wherein the first portion comprises a tray.

8. The application apparatus of claim 7, wherein the second portion comprises a device holder.

9. An application apparatus, comprising:
a package including a cover tray, an ejection element movable with respect to the cover tray, and an electronic device holder wherein the cover tray includes at least one protrusion and the electronic device holder includes at least one recess; and
a protective element disposed in the package;
wherein the cover tray is mateable with the electronic device holder and wherein the at least one protrusion is adapted to extend into the at least one recess such that the cover tray is disposed adjacent to and aligned with the electronic device holder; and
wherein the ejection element is manually displaceable after mating of the cover tray with the electronic device holder to release the protective element from the cover tray.

10. The application apparatus of claim 9, wherein the ejection element comprises a central portion of a recessed portion.

11. The application apparatus of claim 10, wherein the central portion is defined by walls that are capable of retaining the protective element by one of friction or interference.

12. The application apparatus of claim 10, wherein the central portion is defined by a portion comprising an accordion fold.

13. The application apparatus of claim 9, wherein the package further includes an envelope that encloses the protective element.

14. The application apparatus of claim 9, wherein the package, the cover tray, and the electronic device holder form a kit.

15. A method of applying a protective cover to an electronic device, the method comprising the steps of;
providing a kit comprising a package having a cover tray, an electronic device holder, and a protective cover wherein the cover tray includes a movable ejection element;
placing the protective cover in the cover tray;
removing the cover tray and the protective cover from the kit;
placing an electronic device in the electronic device holder;
registering the cover tray with respect to the electronic device holder; and
flexing the movable ejection element to eject the protective element from the cover tray and deposit the protective cover on a desired location of the electronic device.

16. The method of claim 15, wherein the cover tray includes a plurality of protrusions and the electronic device includes a plurality of recesses and wherein the step of registering comprises the step of inserting the protrusions into the recesses.

17. The method of claim 15, wherein the step of flexing comprises the step of moving a central portion of the cover tray.

18. The method of claim 17, wherein central portion is defined by walls that are capable of retaining the protective cover by one of friction or interference.

19. The method of claim 17, wherein the central portion is defined by a portion comprising an accordion fold.
